(19) United States
(12) Patent Application Publication
(10) Pub. No.: US 2016/0180403 A1
(43) Pub. Date: Jun. 23, 2016

(54) SYSTEM AND METHOD FOR CREATING COMPREHENSIVE PROFILE OF ONE OR MORE CUSTOMERS OF AN ORGANIZATION

(71) Applicant: Cognizant Technology Solutions India Pvt. Ltd., Chennai (IN)

(72) Inventors: Jai Ganesh, Bangalore (IN); Bharadwaj Raghuraman, Bangalore (IN)

(21) Appl. No.: 14/722,383

(22) Filed: May 27, 2015

(30) Foreign Application Priority Data
Dec. 23, 2014 (IN) 6502/CHE/2014

(51) Int. Cl. G06Q 30/02; G06Q 50/00

(52) U.S. Cl. CPC G06Q 30/0269; G06Q 50/01

(57) ABSTRACT

A method for creating a comprehensive profile of one or more customers of an organization is provided. The method comprises generating a demographic profile of a customer selected by the organization. The method further comprises generating psychographic profiles and network activity profiles of one or more users of one or more social networks. The generated psychographic profiles and network activity profiles are updated by analyzing them at predetermined intervals of time. The updated psychographic profiles and network activity profiles of each user is then matched with the demographic profile of the selected customer, such that a successful match indicates presence of the selected customer on the one or more social networks. Finally, the comprehensive profile of the selected customer is created by analyzing the demographic profile, the psychographic profile and the network activity profile, the updated psychographic profile and the network activity profile of the selected customer.

### CROSS REFERENCE TO RELATED APPLICATION

This application is related to and claims the benefit of Indian Patent Application Number 6502/CHE/2014 filed on Dec. 23, 2014, the contents of which are herein incorporated by reference in their entirety.

### FIELD OF THE INVENTION

The present invention relates generally to data analytics employing social networks and more particularly, the present invention provides a system and method for analyzing data in the social networks for positioning products and services that are of interest to customers.

### BACKGROUND OF THE INVENTION

The emergence of social networking has fostered knowledge sharing and collaboration among various users. As a result of this, there is an aggregation of highly influential content within these networks. The accumulation of the content, characteristics of the participants, and their interactions on these networks can be valuable to various products and service based organizations. An analysis of the behavior of the users on the social networks assist organizations in understanding user's interests and therefore can help the organizations in positioning right products and services to users and to other users in their networks or groups.

However, to maximize the benefits out of the one or more social networks, the organizations face several challenges. One key issue faced by the organizations is to identify their customers on different social networks. This is because a customer may be a member of different social networks using different aliases and other details. The other issue is presence of variety of data in the social networks. This may include structured, semi-structured, and unstructured data. An estimated 80% of the data in social networks is unstructured in nature and includes comments, feedback, replies etc. Further, this data relates to different content types such as text, audio, video, location, sensor and logs. Analyzing this varied data becomes challenging as different social networks are disparate in terms of user participation and the way content is exchanged between the users.

In light of the above, there is a need for a system and method to facilitate identification and segmentation of customers on different social networks. Further, there is a need for a system and method to monitor and analyze the data associated with the identified customers and other connected users for understanding their behavior and for optimally positioning products and services.

### SUMMARY OF THE INVENTION

In an embodiment of the present invention, a method for creating a comprehensive profile of one or more customers of an organization is provided. The method comprises generating a demographic profile of a customer selected by the organization. The demographic profile is generated using demographic data associated with the selected customer. The demographic data is obtained using keyword based search queries from at least one of: an enterprise database associated with the organization and a third party database. Further one or more demographic variables are identified from the obtained demographic data, the one or more demographic variables are inferences obtained from the demographic data and are used to generate demographic profile of the selected customer.

The method further comprises generating psychographic profiles and network activity profiles of one or more users of one or more social networks. The psychographic profiles and the network activity profiles are created using social network data associated with the one or more users. In an embodiment of the present invention, the one or more users of the one or more social networks are selected by the organization. Further, the criteria used by the organization for selecting the one or more users and the customer are similar. Further, the social network data associated with the one or more users is obtained from the one or more social networks to which the one or more users are subscribed. The social network data comprises at least one of: psychographic data, network activity data, and demographic data associated with the one or more users. In an embodiment of the present invention, the psychographic data is obtained using keyword based search queries and comprises: details of contents like photos, images, documents, presentations, messages, voice notes, audio files, and videos shared by the one or more users on the one or more social networks; details of comments, status, feedbacks, likes, dislikes, preferences, personal biographies, and opinions shared by the one or more users on the one or more social networks; and details of friends or contacts of the one or more users on the one or more social networks. Further, one or more psychographic variables are identified from the obtained psychographic data. The one or more psychographic variables are inferences obtained from the psychographic data and are used to generate psychographic profiles of the one or more users. Further, in an embodiment of the present invention, the network activity data is obtained using keyword based search queries and comprises: number of friends or contacts of the one or more users on the one or more social networks, the different groups associated with the one or more users on the one or more social networks, and details of contacts associated with the one or more users on the one or more social networks. Further, one or more network activity variables are identified from the obtained network activity data. The one or more network activity variables are inferences obtained from the network activity data and are used to generate network activity profiles of the one or more users.

The method further comprises analyzing the generated psychographic profiles and network activity profiles of the one or more users at predetermined intervals of time and updating the generated psychographic profiles and network activity profiles of the one or more users. In an embodiment of the present invention, the method further comprises building, at predetermined intervals of time, network activity profiles for one or more clusters of users associated with the one or more users over one or more social networks.

The method further comprises matching the updated psychographic profiles and network activity profiles of each user of the one or more users with the demographic profile of the selected customer, wherein a successful match indicates presence of the selected customer on the one or more social networks. In an embodiment of the present invention, after the successful match has been identified the remaining users are eliminated from further analysis.

The method further comprises generating, based on the successful match, the comprehensive profile of the selected customer by analyzing the demographic profile of the selected customer, the psychographic profile and the network activity profile of the selected customer, the updated psychographic profile and the network activity profile of the selected customer. Furthermore, the demographic profile, the psychographic profile, the network activity profile, the updated psychographic profile, and the updated network activity profile of the selected customer are analyzed over a period of time to create a group of areas which reflect interests of the selected customer. A predefined weight is then assigned to each interest area for further analysis and for creation of the comprehensive profile of the selected customer. Also, the social networking data, the psychographic profiles, and the network activity profiles of the users with whom the selected customer interacts over the one or more social networks are analyzed. The analysis facilitates identifying key influencers within the one or more social networks of the selected customer.

Further in an embodiment of the present invention, the comprehensive profile conveys one or more aspects of the selected customer, the one or more aspects comprise: behavioral aspects, demographic details, information related to personal and professional networks or contacts, types of interactions with friends, fields of interest, likes and dislikes, response to different products and services, types of opinions, comments, and feedbacks for different products and services consumed by the selected customer, reading habits, preferable tourist destinations, food habits and preferences, types of recreation activities that may be of interest to the selected customer, and one or more preferred brands. The comprehensive profile of the selected customer facilitates the organization in at least one of: optimally positioning products and services to the selected customer and also to users with whom the selected customer interacts over the one or more social networks, sending targeted and relevant advertisement and promotional messages to the selected customer, and offering targeted loyalty programs and gift coupons to the selected customer.

In another embodiment of the present invention, a system for creating a comprehensive profile of one or more customers of an organization is provided. The system comprises a demographic profile module configured to generate a demographic profile of a customer selected by the organization. The demographic profile is generated using demographic data associated with the selected customer. In an embodiment of the present invention, the demographic data is obtained using keyword based search queries from at least one of: an enterprise database associated with the organization and a third party database, further wherein one or more demographic variables are identified from the obtained demographic data, the one or more demographic variables are inferences obtained from the demographic data and are used to generate demographic profile of the selected customer.

The system further comprises a social network module configured to generate psychographic profiles and network activity profiles of one or more users of one or more social networks, wherein the psychographic profiles and the network activity profiles are created using social network data associated with the one or more users. In an embodiment of the present invention, the social network data associated with the one or more users is obtained from the one or more social networks to which the one or more users are subscribed to. Further, the social network data comprises at least one of: psychographic data, network activity data, and demographic data associated with the one or more users. In an embodiment of the present invention, the psychographic data is obtained using keyword based search queries and comprises: details of contents like photos, images, documents, presentations, messages, voice notes, audio files, and videos shared by the one or more users on the one or more social networks; details of comments, status, feedbacks, likes, dislikes, preferences, personal biographies, and opinions shared by the one or more users on the one or more social networks; and details of friends or contacts of the one or more users on the one or more social networks. Further in an embodiment of the present invention, the network activity data is obtained using keyword based search queries and comprises: number of friends or contacts the one or more users engage with on the one or more social networks, the different groups associated with the one or more users on the one or more social networks, and details of contacts associated with the one or more users on the one or more social networks.

The system further comprises an analysis module, a matching module, and a profile generation module. The analysis module is configured to analyze the generated psychographic profiles and network activity profiles of the one or more users at predetermined intervals of time and update the generated psychographic profiles and network activity profiles of the one or more users. The matching module configured to match the updated psychographic profile and network activity profile of each user of the one or more users with the demographic profile of the selected customer, wherein a successful match indicates presence of the selected customer on the one or more social networks. The profile generation module configured to generate, based on the successful match, the comprehensive profile of the selected customer by analyzing the demographic profile of the selected customer, the psychographic profile and the network activity profile of the selected customer, the updated psychographic profile and the network activity profile of the selected customer.

In yet another embodiment of the present invention, a computer program product for creating a comprehensive profile of one or more customers of an organization is provided. The computer program product comprises a non-transitory computer-readable medium having computer-readable program code stored thereon. The computer-readable program code comprises instructions that when executed by a processor, cause the processor to generate a demographic profile of a customer selected by the organization, wherein the demographic profile is generated using demographic data associated with the selected customer. The processor further generates psychographic profiles and network activity profiles of one or more users of one or more social networks, wherein the psychographic profiles and the network activity profiles are created using social network data associated with the one or more users. The processor further analyzes the generated psychographic profiles and network activity profiles of the one or more users at predetermined intervals of time and updates the psychographic profiles and network activity profiles of the one or more users. Furthermore, the processor matches the updated based psychographic profiles and network activity profiles of each user of the one or more users with the demographic profile of the selected customer, wherein a successful match indicates presence of the selected customer on the one or more social networks. The processor further generates, based on the successful match, the comprehensive profile of the selected customer by analyzing the demographic profile of the selected customer, the psychographic profile and the network activity profile of the selected customer, the updated psychographic profile and the network activity profile of the selected customer.

### BRIEF DESCRIPTION OF THE ACCOMPANYING DRAWINGS

The present invention is described by way of embodiments illustrated in the accompanying drawings wherein:

FIG. 1 illustrates a system for creating a comprehensive profile of a customer of an organization, in accordance with an embodiment of the present invention;

FIG. 2 is a block diagram illustrating details of the social network module, in accordance with an embodiment of the present invention;

FIG. 3 illustrates a flowchart depicting a method for creating a comprehensive profile of a customer of an organization, in accordance with an embodiment of the present invention; and

FIG. 4 illustrates an exemplary computer system in which various embodiments of the present invention may be implemented.

### DETAILED DESCRIPTION OF THE INVENTION

The invention provides a system and method for creating a comprehensive profile of a customer of an organization. The comprehensive profile of the customer is created using the demographic data of the customer and the associated social networking data of the customer available in one or more social networks. The comprehensive profile of the customer facilitates the organization in positioning appropriate products and services that may be of interest to the customer and also to the people or groups with whom the customer interacts. The comprehensive profile of the customer further helps the organization in forwarding targeted and relevant advertisement and promotional messages to the customers. The comprehensive profile of the customer further helps the organization in offering targeted loyalty programs and other incentives such as shopping vouchers, gift coupons to the customer.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

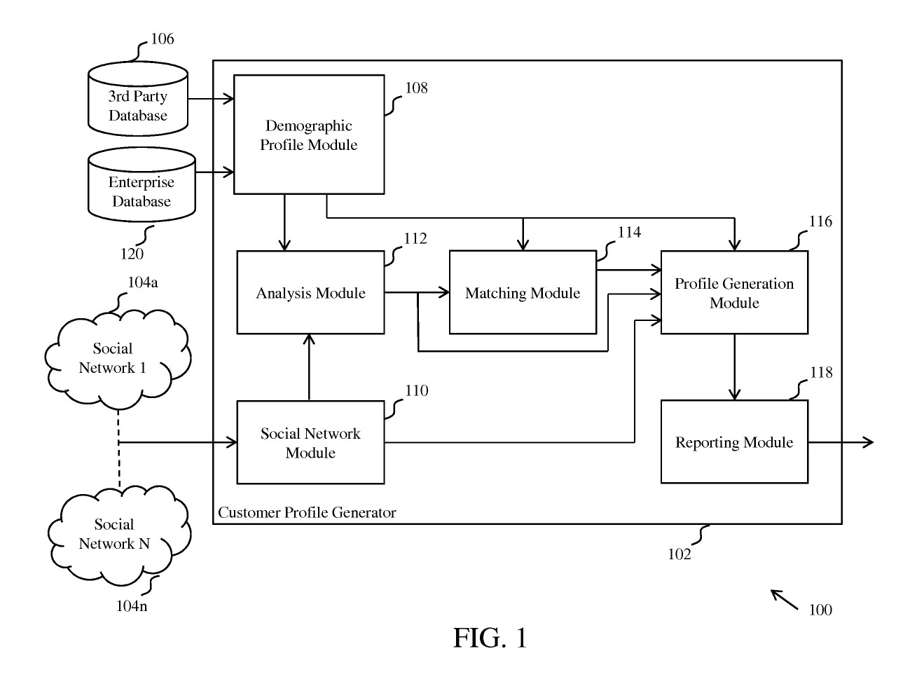

FIG. 1 illustrates a system 100 for creating a comprehensive profile of a customer of an organization, in accordance with an embodiment of the present invention. In various embodiments of the present invention, the organization may be, without any limitation, a bank, an insurance company, a financial services company, a retail store, an e-commerce website, an apparel store, and an eatery. The customer may be associated with the organization by way of purchase of products and services offered by the organization. The system 100 includes a customer profile generator 102 communicatively coupled to one or more social networks 104A-104N and to a third party database 106. The customer profile generator 102 further includes a demographic profile module 108, a social network module 110, an analysis module 112, a matching module 114, a profile generation module 116, and a reporting module 118. The demographic profile module 108 is further communicatively coupled to an enterprise database 120 within the organization which stores various details of the customers of the organization. In various embodiments of the present invention, the various modules of the system 100 may be implemented using hardware, software, or various combinations of hardware and software. The customer profile generator 102 is configured to create the comprehensive profile of the customer of the organization.

In an embodiment of the present invention, the comprehensive profile of the customer provides information related to various aspects of the customer which is used by the organization to optimally position their products and services that may be of interest to the customer. In an embodiment of the present invention, the comprehensive profile of the customer includes various aspects of the customer including, without any limitation, behavioral aspects, demographic details, information related to personal and professional networks or contacts, types of interactions with friends, fields of interest, likes and dislikes, response to different products and services, types of opinions, comments, and feedbacks for different products and services consumed by the customer, reading habits, preferable tourist destinations, food habits and preferences, types of recreation activities that may be of interest to the customer, and one or more preferred brands. It may be apparent to a person of ordinary skill in the art that the different aspects of the customer reflected in his comprehensive profile may not be limited to those as discussed above.

In another embodiment of the present invention, the comprehensive profile of the customer facilitates the organization to identify users or user groups associated with the customer. Based on the identified associated users or user groups, the organization positions relevant products and services. In yet another embodiment of the present invention, based on the comprehensive profile of the customer, the organization disseminates relevant advertisement and promotional messages to customers. In yet another embodiment of the present invention, based on the comprehensive profile of the customer, the organization disseminates loyalty programs and other incentives such as shopping vouchers, gift coupons that may be of interest to the customer.

In an embodiment of the present invention, the comprehensive profile of the customer may be created using data which is captured by analyzing one or more aspects related to the customer in one or more social networks. The comprehensive profile of the customer may also data obtained from the enterprise database 120 within the organization and from the third party database 106. Further, the comprehensive profile is created for a customer selected from a plurality of customers of the organization. The customer may be selected from the plurality of the customers using a search query based on ‘Name’ of the customer, ‘Telephone Number’ of the customer, ‘Postal Address’ of the customer, ‘Email Address’ of the customer, or any other information which is available to the organization.

Referring to the architecture of the customer profile generator 102, the demographic profile module 108 is communicatively coupled to the third party database 106 and the enterprise database 120 using one or more wired or wireless communication links known in the art. In an embodiment of the present invention, the demographic profile module 108 is configured to generate a demographic profile of the customer based on the demographic data associated with the customer. In an embodiment of the present invention, the demographic data associated with the customer may be obtained from the enterprise database 120. In another embodiment of the present invention, the demographic data associated with the customer may be obtained from the third party database 106. In yet another embodiment of the present invention, the demographic data associated with the customer may be obtained from both enterprise database 120 and the third party database 106. Further, in various embodiments of the present invention, the demographic data associated with the customer may include, without any limitation, name of the customer, age of the customer, gender of the customer, ethnicity of the customer, marital status of the customer, income of the customer, family details of the customer, languages known to the customer, email addresses, and postal addresses of the customer.

Further, in an embodiment of the present invention, the demographic profile module 108 obtains the demographic data associated with the customer using keyword based searches. The various keywords that may be used include, without any limitation, age, name, address or location, gender, and marital status. Various demographic variables are then identified from the demographic data that is obtained using the keywords. The demographic variables are the inferences obtained from the demographic data. Further, the variables are entities that would change for each customer. In an exemplary embodiment of the present invention, a search for demographic data using a keyword ‘Age’ fetches the age of the customer. This demographic data associated with the customer, i.e. his age results in identification of variables like ‘Interests’ and ‘Preferences’. These variables facilitate in understanding the tendency or interest or preference of the customer to buy certain products and services appropriate with the age of the customer. Further, the variables ‘Interests’ and ‘Preferences’ may be different for different customers. Similarly, a keyword ‘Gender’ would fetch gender details of the customer. The fetched gender details of the customer would reflect the tendency or interest or preference of the customer to buy certain products and services because of his or her gender. In an example, a male customer would be interested in ‘ties’ and ‘cufflinks’ and a female customer would be interested in buying ‘cosmetic products’. Various other keywords and the associated variable have been listed in TABLE 1. It may be apparent to a person of ordinary skill in the art that these listed keywords and the associated variables are merely for illustration purpose and various other combinations of keywords and variables are possible. Further, in an embodiment of the present invention, the demographic profile module 108 uses these identified associated variables to create a demographic profile of the selected customer.

TABLE 1

| | Demographic | |
|---|---|---|
| Keyword | Variable | Inferences from the Demographic Variables |
| Age | Interests, | The Age group of the customer reflects |
| | Preferences | tendency of the customer to buy certain |
| | | category of products/services |
| Gender | Interests, | The Gender of the customer reflects |
| | Preferences | tendency of the customer to buy certain |
| | | category of products/services |
| Location | Interests, | The Location or address of the customer |
| | Preferences | reflects tendency of the customer to buy |
| | | certain category of products/services at |
| | | that location |
| Marital | Interests, | The Marital Status of the customer reflects |
| Status | Preferences | tendency of the customer to buy certain |
| | | category of products/services |

In an embodiment of the present invention, the social network module 110 is configured to generate psychographic profiles and network activity profiles of one or more users of the one or more social networks 104a-104n. The one or more users of the one or more social networks are selected by the organization. In an embodiment of the present invention, the criteria used by the organization for selecting the one or more users and the customer are similar. Further, the social network module 110 may generate the psychographic profiles and the network activity profiles of the one or more users based on their associated social network data present in the one or more social networks 104a-104n. In exemplary embodiments of the present invention, the one or more social networks 104a-104n with which the customer may be subscribed may include, without any imitation, Facebook, Twitter, Youtube, Orkut, MySpace, Linkedin, Flickr, Delicious, Amazon, eBay, Technorati, Friendster, Tagged, Flixster, Instagram, Wikipedia, Ibibo, Google+, XING, BING, Blogger, Tumblr, Picasa, iTunes, Quora, Reddit, SlideShare, and Scribd. The social network module 110 collects social network data from the one or more social networks 104a-104n via one or more wired or wireless communication links. The social network data associated with the one or more users may include, without any limitation, comments, status, feedbacks, likes, dislikes, preferences, personal biographies, and opinions posted by the users on the one or more social networks 104a-104n; photos, images, documents, presentations, messages, voice notes, audio files, and videos shared by the users on the one or more social networks 104a-104n; blogs and articles associated with the users or that may be of interest to the user; location updates, updates on personal events such as birthdays, and anniversaries shared by the users on the one or more social networks 104a-104n; details of friends, families and other associated contacts of the users; online games played by the users; online music and videos accessed by the users via the one or more social networks 104a-104n; various communities and groups associated with the users, and the bookmarks shared by the users from different social networks.

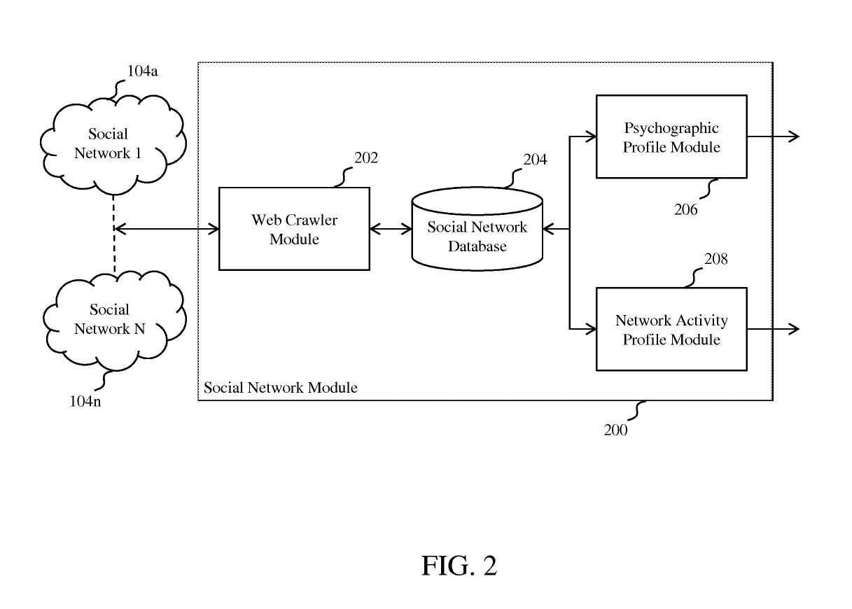

In an embodiment of the present invention, the social network data may be categorized as psychographic data, network activity based data, and demographic data (e.g. location of the user as indicated in one or more social networking websites) associated with the one or more users. The psychographic data associated with the one or more users may include, without any limitation, details of contents like photos, images, documents, presentations, messages, voice notes, audio files, and videos shared on the one or more social networks 104a-104n; details of comments, status, feedbacks, likes, dislikes, preferences, personal biographies, and opinions shared on the one or more social networks 104a-104n; and details of friends or contacts on the one or more social networks 104a-104n. In an embodiment of the present invention, the social network module 110 generates psychographic profiles of the one or more users based on their psychographic data collected from the one or more social networks 104a-104n. The psychographic data for the one or more users is collected from the one or more social networks 104a-104n using keywords and associated psychographic profile variables. The details of the keywords and variables associated with the psychographic profiles of the one more users have been discussed in conjunction with FIG. 2.

The network activity based data associated with the one or more users may include, without any limitation, number of friends or contacts the one or more users engage with on different social networks 104a-n, the different groups associated with the one or more users on the one or more social networks 104a-n, and details of the contacts associated with the one or more users on the one or more social networks 104a-n. In an embodiment of the present invention, the social network module 110 generates network activity profiles of the one or more users based on their network activity based data collected from the one or more social networks. The network activity based data for the one or more users is collected from the one or more social networks using keywords and network activity based variables. The details of the keywords and variables associated with the network activity profiles of the one or more users have been discussed in conjunction with FIG. 2.

The generated psychographic profiles and the generated network activity profiles for the one or more users are then received as inputs by the analysis module 112. In various embodiments of the present invention, the analysis module 112 is configured to monitor activities of the one or more users over the one or more social networks 104a-n to analyze the generated psychographic profiles of the one or more users at predetermined intervals of time and update the generated psychographic profiles of the one or more users and the cluster of users. In another embodiment of the present invention, the analysis module 112 monitors activities of the one or more users over the one or more social networks 104a-n to analyze network activity profiles of the one or more users at predetermined intervals of time and update the generated network activity profiles of the one or more users. The analysis module 112 further builds network activity profiles for a plurality of clusters of users associated with the one or more users at predetermined interval of time. Upon building the network activity profiles for the plurality of clusters of users, the analysis module 112 then generates directed graphs for each cluster spread across different time intervals. In an exemplary embodiment of the present invention, the nodes of the directed graphs indicate the users of the cluster and the edges indicate the relationship between the users of the cluster. The output of the analysis module 112 is then received by the matching module 114.

In an embodiment of the present invention, the matching module 114 is configured to match the updated psychographic profiles and network activity profiles of the one or more users with the demographic profile of the customer of the organization. In an embodiment of the present invention, a match between the updated psychographic profile and the network activity profile of a user of the one or more users with the demographic profile of the customer of the organization confirms the presence of the customer on the one or more social networks 104a-n. In other words, the match indicates to the organization that the user, whose updated psychographic profile and the network activity profile is being matched, is actually the customer of the organization. The matching further corresponds to segmentation of multiple users of the one or more social networks 104a-n into customers of the organization. Further, in an embodiment of the present invention, after a user has been identified as the customer of the organization, the other users of the social networks 104a-n may be eliminated from further analysis.

In an embodiment of the present invention, the matching module 114 may utilize predefined rules to match the psychographic profile and the network activity profile of a user of the one or more users with the demographic profile of the customer of the organization. The predefined rules may include, for example, using the location from metadata associated with activities performed by the one or more users on the social networks. In an exemplary embodiment of the present invention, the matching module 114 may analyze the location associated with a post on Facebook or a location associated with a Tweet on Twitter. The matching module 114 may then match these analyzed locations with the address of the customer in the demographic profile of the customer to confirm if the user present on Facebook and Twitter is the customer of the organization. In another exemplary embodiment of the present invention, the matching module 114 may analyze posts or Tweets on timeline of a user's Facebook or Twitter account to infer that the posts or Tweets relate to birthday wishes. The matching module 114 may then match these inferences with the available birthdate of the customer in his demographic profile to see if there is a matching of the birthdates. A match in such a case may confirm that the user who has received birthday wishes on the social network is indeed the customer of the organization. It may be apparent to a person of ordinary skill in the art that the matching module may apply a plurality of rules, without any limitation, on the available data from the social networks or the psychographic profiles and the network activity profiles of the one or more users to check if it matches with the demographic profile of the customer. Further, after the customer of the organization has been identified on the social networks 140a-n, the details of user or customer are then received by the profile generation module 116.

In an embodiment of the present invention, the profile generation module 116 is configured to generate a comprehensive profile of the customer of the organization. The profile generation module 116 utilizes the generated psychographic profile, network activity profile, and demographic profile of the customer or user to create the comprehensive profile of the customer. The profile generation module 116 further utilizes the psychographic data and the network activity data collected by the social network module 110 to create the comprehensive profile of the customer. Furthermore, the profile generation module 116 utilizes the updated psychographic profiles and network activity profiles of the customer or user to create the comprehensive profile of the customer.

Further, the profile generation module 116 may analyze interactions or activities of the customer on the one or more social networks 104a-n to create the comprehensive profile of the customer. The customer may be active on a variety of topics that may vary depending upon what is popular at a particular time. The different topics which the customer may engage into may include, without any limitation, politics, sports, fashion, movies, music, and education. The profile generation module 116 analyzes all the interactions or activities of the customer over a period of time to create a group of topics which would reflect all the areas in which the user has been active. The profile generation module 116 then accords specific weights to the different topics for further analysis and creation of the comprehensive profile of the customer. A higher weight indicates that the customer is more active for a particular topic. In an embodiment of the present invention, the profile generation module 116 also applies domain or industry specific corpora and taxonomies for segregation of industry specific discussions or activities in which the customer is engaged over the one or more social networks 104a-n. The segregation of industry specific discussions or activities further facilitates creation of the comprehensive profile of the customer.

In an embodiment of the present invention, the profile generation module 116 is self learning in nature and has domain specific intelligence. The different domains may include, without any limitation, retail, banking, financial services, and the like. The profile generation module 116 may employ plurality of learning algorithms including, without any limitation, decision tree learning, association rule learning, artificial neural networks, inductive logic programming, support vector machines, clustering, Bayesian networks, reinforcement learning, and representation learning. The self learning ability of the profile generation module 116 facilitates enrichment of comprehensive profile of the customer over a period of time.

In an embodiment of the present invention, the profile generation module 116 analyzes the social networking data and the psychographic profiles and network activity profiles of the users with whom the customer interacts over the social networks 104a-n. The profile generation module 116 calculates a probabilistic score for each user profile and segments the profiles into groups based on demographics, network activity, temporal, and psychographic profiling. The profile generation module 116 further generates a weighted score for each user profile. In an embodiment of the present invention, the analysis of users with whom the customer interacts facilitates in identifying key influencers within the network of the customer. The key influencers are one or more users who are very active on different social networks 104a-n. The key influencers have a large number of contacts, are subscribed to a plurality of user groups, share large quantities of content with other users, are active in sharing their opinions, comments and feedbacks on different products and services consumed, and engage in discussions on various topics within and outside their networks. The organization may analyze the profiles of these social influencers because of their reachability to a mass audience on the one or more social networks 104a-n. In an embodiment of the present invention, the organization may utilize the social influencers to leverage other users on the social networks 104a-n with regard to the products and services offered by the organization. In an embodiment of the present invention, the social influencers may be customers of the organization. In another embodiment of the present invention, the social influencers are not the customers of the organization.

In an embodiment of the present invention, the profile generation module 116 applies a scoring mechanism to identify most appropriate users from the one or more analyzed users that can be targeted for optimally positioning their products and services, sending targeted and relevant advertisement and promotional messages, offering targeted loyalty programs and other incentives such as shopping vouchers, gift coupons. The scoring mechanism is based on a predefined correlation of the psychographic and network activity profiles of the one or more users and the behavior of the user groups associated with the one or more users.

In an embodiment of the present invention, the output of the profile generation module 116 is received by the reporting module 118. The reporting module 118 is configured to generate a plurality of reports related to the comprehensive profile of the customer and user groups associated with the customer via the one or more social networks 104a-n. The plurality of reports may include, without any limitation, summary reports and page-wise detailed reports. The plurality of reports facilitates visual tracking of the dynamic changes in the interaction patterns of the customer and the user groups associated with the customer via the one or more social networks 104a-n. The plurality of reports further facilitate decision makers associated with the organization to maintain a chain of events with regard to the comprehensive profile of the customer and the user groups associated with the customer via the one or more social networks 104a-n. In exemplary embodiments of the present invention, the reporting module 118 generates reports in formats including, without any limitation, Portable Document Format (PDF) and Hyper Text Markup Language (HTML).

In an embodiment of the present invention, the system 100 may be accessed by an enterprise customer analytics team associated with the organization for creating the comprehensive profile of the customer. The enterprise customer analytics team may access the system 100 via one or more devices in communication with the system 100 including, without any limitation, a television via a wired or wireless communication links, a desktop computer using a web browser; a smart phone or any handheld device using the web browser or a software application; and a head mounted display.

FIG. 2 is a block diagram illustrating details of the social network module in accordance with an embodiment of the present invention. The social network module 200 comprises a web crawler module 202, a social network database 204, a psychographic profile module 206, and a network activity profile module 208. Further, the social network module 200 is communicatively coupled to the one or more social networks 104a-n via any wired or wireless communication link known in the art. In various embodiments of the present invention, the various modules of the social network module 200 may be implemented using hardware, software, or various combinations of hardware and software. In an embodiment of the present invention, the web crawler module 202 is configured to fetch social network data from the plurality of social networks 104a-n over the Internet. The web crawler module 202 fetches webpage content or source codes corresponding to the Uniform Resource Locators (URLs) provided by the user by connecting to the Internet. Once the webpage is obtained, the web crawler module 202 then parses through the content of the webpage and generates a crawler Extensible Markup Language (XML) format file. In an embodiment of the present invention, while generating the crawler XML file, the web crawler module 202 filters out unwanted information from the webpage i.e., it collects the metadata from the webpage elements which are of interest and required by other modules for further processing of the social network data. The generated crawler XML files are then stored in the social network database 204.

In an embodiment of the present invention, the social network database 204 may be a memory or a storage device operable to store the social network data in the form of generated crawler XML files. For example, social network database 204 may be a Random-Access Memory (RAM), a Read-Only Memory (ROM), an optical storage device, a magnetic media, etc., either integrated with the social network module 200 or configured as a separate device. Further, the social network data comprises psychographic data and network activity data. The psychographic data is used by the psychographic profile module 206 to generate psychographic profiles of the one or more users of the social networks 104a-n. The network activity data is used by the network activity profile module 208 to generate network activity profiles of the one or more users of the social networks 104a-n. In an embodiment of the present invention, the social network data is used by the profile generation module (FIG. 1) to generate or enrich the comprehensive profile of the customer of the organization and other users which are there in the network of the customer. Further, the social network database 204 may have semantic features to match across the keywords and user profiles.

In an embodiment of the present invention, the psychographic profile module 206 is configured to generate psychographic profiles for the one or more users of the social networks 104a-n. The psychographic profile module 206 facilitates obtaining the psychographic data from the social networks 104a-n using keyword based searches. The various keywords that may be used include, without any limitation, work experience, volunteer experience, education, honors, awards, skills, certifications, courses, publications, patents, interests and activities. Various psychographic variables are then identified from the psychographic data that is obtained using the keywords. The psychographic variables facilitate identification of psychographic attributes of the one or more users uniformly from plurality of disparate social networks 104a-n. The psychographic profile module 202 uses these identified psychographic variables to create the psychographic profiles of the one or more users.

In an embodiment of the present invention, the psychographic variables may include, without any limitation, credibility, personality, skills set, education level, experience, and language skills. Each of these variables may vary for the one or more users and may convey different psychographic attribute of the each of the one or more users. In an exemplary embodiment of the present invention, a search for the psychographic data with keyword ‘Work Experience’ may fetch different work experiences of the one or more users from different social networks 104a-n. The fetched data may result in identification of psychographic variables like ‘Credibility’ and ‘Personality’. In an example, a user with 5 years of work experience at a single organization may appear to be more ‘Credible’ than another user with 2 years of experience at two or more organizations. Further, the ‘Personality’ of the user with 5 years of work experience at a single organization may appear to be more adaptive than the another user with 2 years of experience at two or more organizations. Various other psychographic keywords and the psychographic variables have been listed in TABLE 2.

TABLE 2

| Social | | Psychographic | Inferences from the Psychographic |
|---|---|---|---|
| Network | Keyword | Variable | Variables |
| LinkedIn | Work | Credibility; | Indirect indication of credibility |
| | experience, | | (trustable, capable) of the user; |
| | Volunteer | Personality; | Shows Consciousness of user; |
| | experience | Work experience; | Shows the work skills/experience of |
| | | | the one or more users; |
| | | Skills set | Reflects whether a user is an adaptive |
| | | | person |
| LinkedIn | Education, | Skills set | Indicator of knowledge level or skills |
| | Honors and | Education level | of the one or more users |
| | Awards, | Personality | |
| | Skills, | | |
| | certifications, | | |
| | Courses | | |
| LinkedIn | Publications, | Experience | An indication of creativity, ambition |
| | Patents | | and ability to work |
| | filed/granted | | |
| LinkedIn | Languages | Language skills | Language skills of the one or more |
| | | | users |
| Facebook | Interests | Personality | Indirect reflection of the users' |
| | (Music, | | personality: |
| | Sports, | | 1 - Type of music: |
| | Books and | | 1a - Rock, RnB- extroverts, passionate; |
| | Movies etc.), | | 1b. Jazz, Blues: Independent, Creative; |
| | Activities | | 1c. Vocal, classical: Calm, organized |
| | | | etc. |
| | | | 2. Books/Movies |
| | | | 2a - Romantic: Fantasy and Dreamer; |
| | | | 2b - Mystery: Analytical; |
| | | | 2c - War and Action: Adventurous and |
| | | | Extrovert; |
| | | | 2d - Science Fiction: Creative and |
| | | | Open minded |
| | | | 3. Sports |
| | | | 3a - Team/Group Sports: Suggests that |
| | | | the user prefers active social circle |
| | | | 3b - Solo/Individuals Sports: Suggests |
| | | | that the user is an introvert and prefers |
| | | | a narrow social circle |

In an embodiment of the present invention, the network activity profile module 208 is configured to generate network activity profiles for the one or more users of the one or more social networks 104a-n. The network activity profile module 208 facilitates obtaining the network activity data from the one or more social networks 104a-n using keyword based searches. The various keywords that may be used include, without any limitation, following, follower, re-tweet, contacts, Wall count, Twitter Count, likes, recommendation, subscription, membership, joined, replies, shares, connections, counts, network statistics, groups, connections, and networks. Various network activity based variables are then identified from the network activity data that is obtained using the keywords. The network activity based variables facilitate identification of network activity based attributes of the one or more users uniformly from plurality of disparate social networks 104a-n. The network activity profile module 208 uses these identified network activity based variables to create the network activity profiles of the one or more users.

In an embodiment of the present invention, the network activity based variables may include, without any limitation, social network relationships, social activity level, ambitious, career minded, personality, interests in a specific area, and skills set. Each of these network activity based variables may vary for the one or more users and may convey different network activity attribute of the each of the one or more users. In an exemplary embodiment of the present invention, a search for the network activity data with keyword ‘Connections’ may fetch a count of the connections or contacts of the one or more users. The fetched data may result in identification of network activity based variables like ‘Social activity level’. In an example, a user with 500 contacts in two years of time may indicate that the ‘Social Activity Level’ of this user is higher than another user who has 50 contacts in the same time frame. Further, 20-25 Facebook ‘Likes’ in a day by the user may indicate Interest of the user in a specific area. Various other network activity based keywords and the network activity based variables have been listed in TABLE 3.

TABLE 3

| Social | | Network Activity | Inferences from the Network Activity |
|---|---|---|---|
| Network | Keyword | Based Variables | Based Variables |
| LinkedIn | Following | Interest in a specific | Shows interests in specific companies |
| | (People, | area | and industries |
| | companies, | Personality | How socially aware the individual is |
| | Industries), | | Indicator of interests and likes |
| | Group | | |
| | associations: | | |
| | Joined | | |
| LinkedIn | Interests | Skills set | Specific likes and interests |
| Twitter | Membership | Social network | Affiliations the individual is involved with |
| | Joined, | relationship | Indicator of social active level |
| | Subscriptions | | Personality indicator: Extrovert and |
| | | | openness to new experience(confound) |
| Twitter | Twitter Count | Social activity level | Indirect indication of individual's |
| | | Personality | personality: Inspiring, Extrovert |
| | | | Shows how socially active person is |
| Twitter | Following | Social activity level | Indicator of how cooperative the |
| | (Connections) | | individual is |
| Twitter | Follower | Social network | How socially desirable the individual is |
| | Count | relationship | to others |
| Twitter | Re-tweet, | Ambitious, | What the individual values/considers |
| | replies | Career minded | being important. This can be either |
| | | | personal identity formation or |
| | | | motivational drive |
| Facebook | Wall count | Personality | How comfortable is the individual to |
| | | People's attitude | communicate with others |
| | | towards the user | Indirect indication of people's attitude |
| | | | towards the candidate: Positive, |
| | | | Negative |
| | | | Personality Indication: Extrovert, |
| | | | Enthusiastic |
| Facebook | Likes | Interest in a specific | How socially aware the candidate is to |
| | | area | a particular organization or industry |
| | | | May also reflect individual's interests |
| YouTube | Video Count | Social active level | How socially active the person is |
| YouTube | Like Count | Personality | The individual is presentable, creative, |
| | | | organized, attention catching, inspiring |
| | | | or enthusiastic |
| YouTube | Favorite | Personality | Reflects that the individuals receives a |
| | Count, | Ability | strong positive impression from others |
| | Subscribers | Skills set | Indicator of the individual's ability: |
| | Count | | good organization, good presentations |
| | | | skills and attention catching |
| | | | How favorable the individual is |
| | | | Leadership skills |
| LinkedIn | Connection | Social network | How socially connected/desired the |
| | Counts | relationship | individual is |
| | | Personality | Indirect indicator of friendliness, |
| | | | cooperative and extrovert personality |
| LinkedIn | Recommenda- | Credibility | Indicator of credibility |
| | tions (number | Social network | Indirect indicator of good social |
| | and the | relationship | network relationship |
| | context) | | Indirect indicator of people's attitude |
| | | | towards to the candidates: Positive, |
| | | | responsible and capable |
| LinkedIn | Network | Social active level | Activities may reflect individuals' |
| | Statistics | Social network | social active level |
| | | relationship | Networks reflect the affiliation the |
| | | | individual has and also indicates the |
| | | | social circle/activity of the candidate |
| LinkedIn | Associations | Interest in specific | Show the interest in specific company |
| | | area | or area |
| Facebook | Networks | Social activity level | Activities may reflect individuals' |
| | | Social network | social activity level |
| | | relationship | Networks reflect the affiliation the |
| | | | individual has |

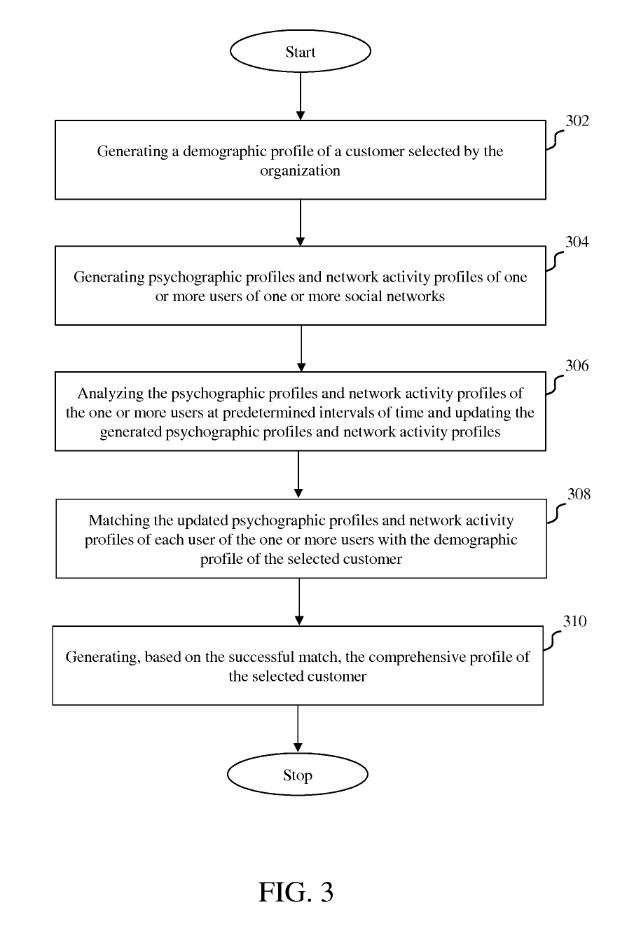

FIG. 3 illustrates a flowchart depicting a method for creating a comprehensive profile of a customer of an organization in accordance with an embodiment of the present invention.

At step 302, a demographic profile of a customer selected by the organization is generated. In an embodiment of the present invention, the customer may be selected from the plurality of customers of the organization using a search query based on ‘Name’ of the customer, ‘Telephone Number’ of the customer, ‘Postal Address’ of the customer, ‘Email Address’ of the customer, or any other information which is available to the organization. The demographic profile of the customer is generated using demographic data associated with the customer. The demographic data associated with the customer may include, without any limitation, name of the customer, age of the customer, gender of the customer, ethnicity of the customer, marital status of the customer, income of the customer, family details of the customer, languages known to the customer, email addresses, and postal addresses of the customer. The demographic data may be fetched from an enterprise database and/or a third party database using keyword based search queries. After the demographic data has been fetched, various demographic variables are identified from the fetched demographic data. The one or more demographic variables are inferences obtained from the demographic data and are used to generate demographic profile of the selected customer.

At step 304, psychographic and network activity profiles of the one or more users of plurality of social networks are generated. In an embodiment of the present invention, the one or more users of the one or more social networks are selected by the organization. Further, the criteria used by the organization for selecting the one or more users and the customer are similar. Further, the psychographic and network activity profiles of the one or more users is generated using the psychographic and network activity data associated with the customer and present in the plurality of social networks. In an embodiment of the present invention, the psychographic data associated with the one or more users is obtained using keyword based search queries and may include, without any limitation, details of contents like photos, images, documents, presentations, messages, voice notes, audio files, and videos shared on different social networks; details of comments, status, feedbacks, likes, dislikes, preferences, personal biographies, and opinions shared on different social networks; and details of number of friends or contacts on different social networks. Further, one or more psychographic variables are identified from the obtained psychographic data. The one or more psychographic variables are inferences obtained from the psychographic data and are used to generate psychographic profiles of the one or more users.

Further in an embodiment of the present invention, the network activity based data associated with the one or more users is obtained using keyword based search queries and may include, without any limitation, number of friends or contacts the one or more users engage with on different social networks, the different groups on different social networks to which the one or more users are subscribed to, and details of the contacts with whom the one or more users interact most on different social networks. Further, one or more network activity variables are identified from the obtained network activity data. The one or more network activity variables are inferences obtained from the network activity data and are used to generate network activity profiles of the one or more users.

At step 306, an analysis of the generated psychographic profiles and network activity profiles of the one or more users at predetermined intervals of time is performed. Based on the analysis, the generated psychographic profiles and network activity profiles of the one or more users are updated. In an embodiment of the present invention, monitoring of the activities of the one or more users over the plurality of social networks is analyzed to build psychographic profiles and network activity profiles for the predetermined intervals of time for the one or more users and for on or more cluster of users associated with the one or more users over one or more social networks. In an embodiment of the present invention, the demographic profile, the psychographic profile, the network activity profile, the updated psychographic profile, and the updated network activity profile of the selected customer is analyzed over a period of time to create a group of areas which reflect interests of the selected customer. After the interest areas are created, a predefined weight is then accorded to each interest area for further analysis and for creation of the comprehensive profile of the selected customer. Further in an embodiment of the present invention, the social networking data, the psychographic profiles, and the network activity profiles of the users with whom the selected customer interacts over the one or more social networks are analyzed. The analysis facilitates identifying key influencers within the one or more social networks of the selected customer.

At step 308, a matching of the updated psychographic profiles and network activity profiles of each user of the one or more users with the demographic profile of the selected customer is performed. In an embodiment of the present invention, a successful match indicates presence of the selected customer on the one or more social networks. Further, in an embodiment of the present invention, after the successful match has been identified as the customer of the organization, the other of remaining users of the social networks 104a-n may be eliminated from further analysis.

At step 310, a comprehensive profile of the customer or the identified user is generated using the psychographic profile, the network activity profile, and demographic profile of the customer. The psychographic data and the network activity data collected from the social networks are also used to create the comprehensive profile of the customer. Further, the updated psychographic profiles and network activity profiles of the customer are also used to create the comprehensive profile of the customer. In an embodiment of the present invention, the comprehensive profile conveys one or more aspects of the selected customer, the one or more aspects comprise: behavioral aspects, demographic details, information related to personal and professional networks or contacts, types of interactions with friends, fields of interest, likes and dislikes, response to different products and services, types of opinions, comments, and feedbacks for different products and services consumed by the selected customer, reading habits, preferable tourist destinations, food habits and preferences, types of recreation activities that may be of interest to the selected customer, and one or more preferred brands.

The created comprehensive profile of the selected customer is further enriched over time using one or more self learning algorithms. Further, in an embodiment of the present invention, the organization may use the generated comprehensive profile of the customer to optimally position their products and services to the customer. In another embodiment of the present invention, the generated comprehensive profile of the customer facilitates the organization to identify users or user groups associated with the customer. Based on the identified associated users or user groups, the organization positions relevant products and services. In yet another embodiment of the present invention, based on the generated comprehensive profile of the customer, the organization disseminates relevant advertisement and promotional messages to customers. In yet another embodiment of the present invention, based on the generated comprehensive profile of the customer, the organization disseminates loyalty programs and other incentives such as shopping vouchers, gift coupons that may be of interest to the customer.

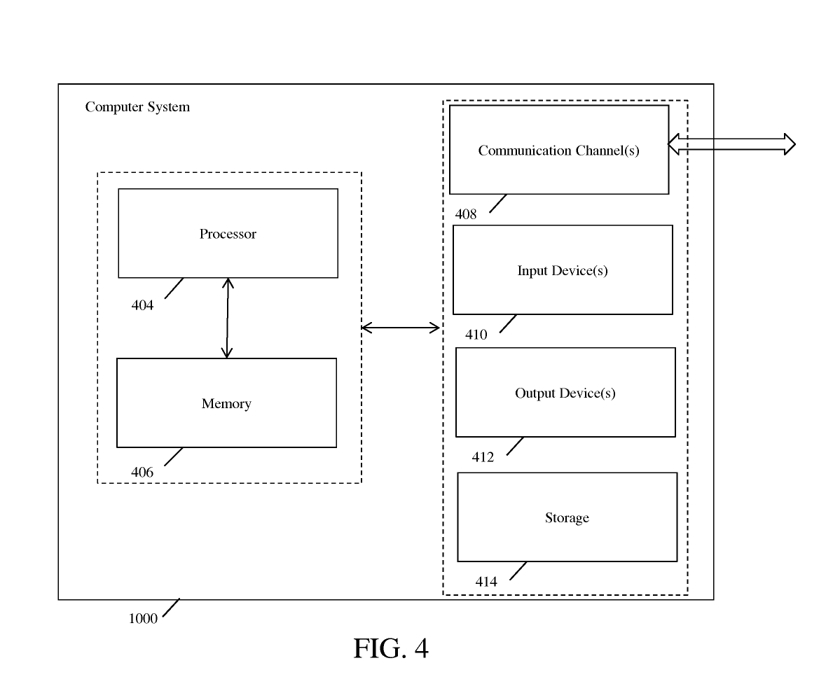

FIG. 4 illustrates an exemplary computer system in which various embodiments of the present invention may be implemented.

The computer system 4902 comprises a processor 404 and a memory 406. The processor 404 executes program instructions and may be a physical processor. The processor 404 may also be a virtual processor. The computer system 402 is not intended to suggest any limitation as to scope of use or functionality of described embodiments. For example, the computer system 402 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 406 may store software for implementing various embodiments of the present invention. The computer system 402 may have additional components. For example, the computer system 402 includes one or more communication channels 408, one or more input devices 410, one or more output devices 412, and storage 414. An interconnection mechanism (not shown) such as a bus, controller, or network, interconnects the components of the computer system 402. In various embodiments of the present invention, operating system software (not shown) provides an operating environment for various software executing in the computer system 402, and manages different functionalities of the components of the computer system 402.

The communication channel(s) 408 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 410 may include, but not limited to, a keyboard, mouse, pen, joystick, trackball, a voice device, a scanning device, or any another device that is capable of providing input to the computer system 402. In an embodiment of the present invention, the input device(s) 410 may be a sound card or similar device that accepts audio input in analog or digital form. The output device(s) 412 may include, but not limited to, a user interface on CRT or LCD, printer, speaker, CD/DVD writer, or any other device that provides output from the computer system 402.

The storage 414 may include, but not limited to, magnetic disks, magnetic tapes, CD-ROMs, CD-RWs, DVDs, flash drives or any other medium which can be used to store information and can be accessed by the computer system 402. In various embodiments of the present invention, the storage 414 contains program instructions for implementing the described embodiments.

The present invention may suitably be embodied as a computer program product for use with the computer system 402. The method described herein is typically implemented as a computer program product, comprising a set of program instructions which is executed by the computer system 402 or any other similar device. The set of program instructions may be a series of computer readable codes stored on a tangible medium, such as a computer readable storage medium (storage 414), for example, diskette, CD-ROM, ROM, flash drives or hard disk, or transmittable to the computer system 402, via a modem or other interface device, over either a tangible medium, including but not limited to optical or analogue communications channel(s) 408. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A method for creating a comprehensive profile of one or more customers of an organization, the method comprising:
generating a demographic profile of a customer selected by the organization, wherein the demographic profile is generated using demographic data associated with the selected customer;
generating psychographic profiles and network activity profiles of one or more users of one or more social networks, wherein the psychographic profiles and the network activity profiles are created using social network data associated with the one or more users;
analyzing the generated psychographic profiles and network activity profiles of the one or more users at predetermined intervals of time and updating the generated psychographic profiles and network activity profiles of the one or more users;
matching the updated psychographic profiles and network activity profiles of each user of the one or more users with the demographic profile of the selected customer, wherein a successful match indicates presence of the selected customer on the one or more social networks; and
generating, based on the successful match, the comprehensive profile of the selected customer by analyzing the demographic profile of the selected customer, the psychographic profile and the network activity profile of the selected customer, and the updated psychographic profile and the network activity profile of the selected customer.

2. The method of claim 1, wherein the demographic data is obtained using keyword based search queries from at least one of: an enterprise database associated with the organization and a third party database, further wherein one or more demographic variables are identified from the obtained demographic data, the one or more demographic variables are inferences obtained from the demographic data and are used to generate demographic profile of the selected customer.

3. The method of claim 1, wherein the one or more users of the one or more social networks are selected by the organization, further wherein criteria used by the organization for selecting the one or more users and the customer are similar.

4. The method of claim 1, wherein the social network data associated with the one or more users is obtained from the one or more social networks to which the one or more users are subscribed, further wherein the social network data comprises at least one of: psychographic data, network activity data, and demographic data associated with the one or more users.

5. The method of claim 4, wherein the psychographic data is obtained using keyword based search queries, further wherein the psychographic data comprises: details of contents like photos, images, documents, presentations, messages, voice notes, audio files, and videos shared by the one or more users on the one or more social networks; details of comments, status, feedbacks, likes, dislikes, preferences, personal biographies, and opinions shared by the one or more users on the one or more social networks; and details of friends or contacts of the one or more users on the one or more social networks.

6. The method of claim 5, wherein one or more psychographic variables are identified from the obtained psychographic data, the one or more psychographic variables are inferences obtained from the psychographic data and are used to generate psychographic profiles of the one or more users.

7. The method of claim 4, wherein the network activity data is obtained using keyword based search queries, further wherein the network activity data comprises: number of friends or contacts of the one or more users on the one or more social networks, the different groups associated with the one or more users on the one or more social networks, and details of contacts associated with the one or more users on the one or more social networks.

8. The method of claim 7, wherein one or more network activity variables are identified from the obtained network activity data, the one or more network activity variables are inferences obtained from the network activity data and are used to generate network activity profiles of the one or more users.

9. The method of claim 1 further comprises building, at predetermined intervals of time, network activity profiles for one or more clusters of users associated with the one or more users over one or more social networks.

10. The method of claim 1 further comprises eliminating, after the successful match has been identified, remaining users from further analysis.

11. The method of claim 1 further comprises analyzing the demographic profile, the psychographic profile, the network activity profile, the updated psychographic profile, and the network activity profile of the selected customer over a period of time to create a group of areas which reflect interests of the selected customer, further wherein a predefined weight is then assigned to each interest area for further analysis and for creation of the comprehensive profile of the selected customer.

12. The method of claim 1 further comprises analyzing the social networking data, the psychographic profiles, and the network activity profiles of the users with whom the selected customer interacts over the one or more social networks, further wherein the analysis facilitates identifying key influencers within the one or more social networks of the selected customer.

13. The method of claim 1, wherein the comprehensive profile conveys one or more aspects of the selected customer, the one or more aspects comprise: behavioral aspects, demographic details, information related to personal and professional networks or contacts, types of interactions with friends, fields of interest, likes and dislikes, response to different products and services, types of opinions, comments, and feedbacks for different products and services consumed by the selected customer, reading habits, preferable tourist destinations, food habits and preferences, types of recreation activities that may be of interest to the selected customer, and one or more preferred brands.

14. The method of claim 1, wherein the comprehensive profile of the selected customer facilitates the organization in at least one of: optimally positioning products and services to the selected customer and also to users with whom the selected customer interacts over the one or more social networks, sending targeted and relevant advertisement and promotional messages to the selected customer, and offering targeted loyalty programs and gift coupons to the selected customer.

15. A system for creating a comprehensive profile of one or more customers of an organization, the system comprising:
a demographic profile module configured to generate a demographic profile of a customer selected by the organization, wherein the demographic profile is generated using demographic data associated with the selected customer;
a social network module configured to generate psychographic profiles and network activity profiles of one or more users of one or more social networks, wherein the psychographic profiles and the network activity profiles are created using social network data associated with the one or more users;
an analysis module configured to analyze the generated psychographic profiles and network activity profiles of the one or more users at predetermined intervals of time and update the generated psychographic profiles and network activity profiles of the one or more users;
a matching module configured to match the updated psychographic profile and network activity profile of each user of the one or more users with the demographic profile of the selected customer, wherein a successful match indicates presence of the selected customer on the one or more social networks; and
a profile generation module configured to generate, based on the successful match, the comprehensive profile of the selected customer by analyzing the demographic profile of the selected customer, the psychographic profile and the network activity profile of the selected customer, and the updated psychographic profile and the network activity profile of the selected customer.

16. The system of claim 15, wherein the demographic data is obtained using keyword based search queries from at least one of: an enterprise database associated with the organization and a third party database, further wherein one or more demographic variables are identified from the obtained demographic data, the one or more demographic variables are inferences obtained from the demographic data and are used to generate demographic profile of the selected customer.

17. The system of claim 15, wherein the social network data associated with the one or more users is obtained from the one or more social networks to which the one or more users are subscribed to, further wherein the social network data comprises at least one of: psychographic data, network activity data, and demographic data associated with the one or more users.

18. The system of claim 17, wherein the psychographic data is obtained using keyword based search queries, further wherein the psychographic data comprises: details of contents like photos, images, documents, presentations, messages, voice notes, audio files, and videos shared by the one or more users on the one or more social networks; details of comments, status, feedbacks, likes, dislikes, preferences, personal biographies, and opinions shared by the one or more users on the one or more social networks; and details of friends or contacts of the one or more users on the one or more social networks.

19. The system of claim 17, wherein the network activity data is obtained using keyword based search queries, further wherein the network activity data comprises: number of friends or contacts the one or more users engage with on the one or more social networks, the different groups associated with the one or more users on the one or more social networks, and details of contacts associated with the one or more users on the one or more social networks.

20. A computer program product comprising:
a non-transitory computer-readable medium having computer-readable program code stored thereon, the computer-readable program code comprising instructions that when executed by a processor, cause the processor to:
generate a demographic profile of a customer selected by the organization, wherein the demographic profile is generated using demographic data associated with the selected customer;
generate psychographic profiles and network activity profiles of one or more users of one or more social networks, wherein the psychographic profiles and the network activity profiles are created using social network data associated with the one or more users;
analyze the generated psychographic profiles and network activity profiles of the one or more users at predetermined intervals of time and update the generated psychographic profiles and network activity profiles of the one or more users;
match the updated based psychographic profiles and network activity profiles of each user of the one or more users with the demographic profile of the selected customer, wherein a successful match indicates presence of the selected customer on the one or more social networks; and
generate, based on the successful match, the comprehensive profile of the selected customer by analyzing the demographic profile of the selected customer, the psychographic profile and the network activity profile of the selected customer, and the updated psychographic profile and the network activity profile of the selected customer.
